(19) United States
(12) Patent Application Publication
(10) Pub. No.: US 2026/0042704 A1
(43) Pub. Date: Feb. 12, 2026

(54) METHODS OF DEPOSITING LINER LAYERS OF THROUGH GLASS VIA

(71) Applicant: Applied Materials, Inc., Santa Clara, CA (US)

(72) Inventors: Dong Kil YIM, Pleasanton, CA (US); Changling LI, San Jose, CA (US); Lai ZHAO, Campbell, CA (US); Soo Young CHOI, Fremont, CA (US)

(21) Appl. No.: 18/799,955

(22) Filed: Aug. 9, 2024

(51) Int. Cl. C03C 17/00; C03C 17/36

(52) U.S. Cl. CPC C03C 17/004; C03C 17/3618; C03C 17/3634; C03C 2218/152

(57) ABSTRACT

Implementations of the present disclosure generally relate to liner layers and methods of forming liner layers for through glass vias. In one or more implementations, a liner layer is deposited on a glass substrate having a plurality of vias disposed through the glass substrate. The method includes depositing an adhesion layer onto and in a via of the plurality of vias to form the adhesion layer, the adhesion layer having a thickness of about 100 Angstroms to about 550 Angstroms, a tensile stress of about −30 MPa to about 80 MPa, and a Young's modulus of about 115 GPa to about 200 GPa and depositing a second layer onto the adhesion layer, the second layer having a thickness of about 2,000 Angstroms to about 60,000 Angstroms, a compressive stress greater than about −50 MPa, and a Young's modulus of about 35 GPa to about 70 GPa.

### BACKGROUND

### Field

The present disclosure generally relates to liner layers for through glass vias, and more particularly, to liner layers utilized to prevent delamination between through glass vias and liner layers.

### Description of the Related Art

Through glass vias (TGVs) are a technology utilized for semiconductor chip packaging and electronic devices. These through-substrate interconnects allow electronic devices to be stacked vertically for a broad range of applications and performance improvements such as increased bandwidth, reduced signal delay, improved power management, and smaller form-factors. Typically TGVs are filled with copper to allow electrical signals to be transmitted from one side of the glass to another. However, due to the different mechanical properties of glass and copper, a buffer layer or liner layer is needed between the two to ensure proper adhesion and to absorb thermal expansion difference between glass and copper. Plasma-enhanced chemical vapor deposition (PECVD) tetraethoxysilane (TEOS) based silicon dioxide (SiO) has been used as a liner layer for TGVs to improve adhesion between the glass substrate and the copper interconnect.

However, voids/delaminations of the conventional liner layers from the glass core has been observed on the corners of the TGVs. Exemplary delamination is illustrated in FIG. 1, where the silicon dioxide liner layer 103 (deposited by TEOS) of stack 100 has lifted away from the glass substrate 101 forming delamination blister 102. The delamination is due, in part, to the compressive stress of PECVD TEOS based SiO liner layer. Compressive stress occurs when the atoms of the liner layer are closer together than they were in the annealed state. As a result, the liner layer will attempt to expand causing convex bowing as shown in FIG. 2b. FIG. 2a alternately shows a liner layer 104 with tensile stress that undergoes concave bowing. Other factors contributing to delamination can include surface contaminants, liner layer thickness, the coefficient of linear thermal expansion, and small Young's modulus of the liner layer. Liner layer delamination is a detrimental defect that disrupts the performance of the device and can result in failure of the device.

Therefore, there is a need for improved liner layers and methods to deposit liner layers to prevent delamination between TGVs and liner layers and the conductive features.

### SUMMARY

Implementations of the present disclosure generally relate to liner layers and methods of forming liner layers on through glass vias for the production of semiconductor chip packaging and electronic devices. More particularly, implementations described herein provide methods for forming liner layers that prevents delamination between through glass vias and the liner layers.

In at least one implementation, a method of forming a liner layer in a via formed on or in a substrate is provided. The method includes depositing an adhesion layer having a thickness of about 100 Angstroms to about 550 Angstroms, a tensile stress of about −30 MPa to about 80 MPa, and a Young's modulus of about 115 GPa to about 200 GPa onto and in a via and depositing a second layer onto the adhesion layer, the second layer having a thickness of about 2,000 Angstroms to about 60,000 Angstroms, a compressive stress greater than about −50 MPa, and a Young's modulus of about 35 GPa to about 70 GPa.

In at least one implementation, a method of forming a liner layer in a via formed on or in a substrate is provided. The method includes depositing an adhesion layer having a thickness of about 100 Angstroms to about 550 Angstroms, a tensile stress of about −30 MPa to about 200 MPa, and a Young's modulus of about 1 GPa to about 50 GPa onto and in a via and depositing a second layer onto the adhesion layer, the second layer having a thickness of about 2,000 Angstroms to about 60,000 Angstroms, a compressive stress greater than about −50 MPa, and a Young's modulus of about 35 GPa to about 70 GPa.

In at least one implementation, a liner layer stack includes a glass substrate, the glass substrate including a plurality of vias disposed through the glass substrate. The liner layer stack includes an adhesion layer disposed on the glass substrate and in at least one via of the plurality of vias, the adhesion layer having a thickness of about 100 Angstroms to about 550 Angstroms and one or more of a tensile stress of about −30 MPa to about 200 MPa and/or a Young's modulus of about 115 GPa to about 200 GPa.

In at least one implementation, an interposer panel includes a glass substrate having a first surface and a second surface opposing the first surface. The glass substrate includes a plurality of through glass vias (TGVs) disposed through the glass substrate, at least one TGV having: an aspect ratio of a width to a height of about 1:3 to about 1:40; an adhesion layer disposed on the sidewalls of a respective TGV and on the first surface and the second surface of the glass substrate, the adhesion layer having a thickness of about 20 Angstroms to about 400 Angstroms, a tensile stress of about −15 MPa to about 80 MPa, and a Young's modulus of about 120 GPa to about 200 GPa; a second layer disposed over the adhesion layer on the sidewalls of the respective TGV and disposed over the first surface and the second surface, the second layer having a thickness of about 2,000 Angstroms to about 60,000 Angstroms; and a metal material disposed in the respective TGV and on the second layer over the first surface and the second surface of the glass substrate.

In at least one implementation, an interposer panel includes a glass substrate having a first surface and a second surface opposing the first surface. The glass substrate includes a plurality of through glass vias (TGVs) disposed through the glass substrate, at least one TGV having: an aspect ratio of a width to a height of about 1:3 to about 1:40; an adhesion layer disposed on the sidewalls of a respective TGV and on the first surface and the second surface of the glass substrate, the adhesion layer having a thickness of about 250 Angstroms to about 720 Angstroms and a tensile stress of about 30 MPa to about 200 MPa; a second layer disposed over the adhesion layer on the sidewalls of the respective TGV and disposed over the first surface and the second surface, the second layer having a thickness of about 2,000 Angstroms to about 60,000 Angstroms; and a metal material disposed in the respective TGV and on the second layer over the first surface and the second surface of the glass substrate.

In at least one implementation, an interposer panel includes a glass substrate having a first surface and a second surface opposing the first surface. The glass substrate includes a plurality of through glass vias (TGVs) disposed through the glass substrate, at least one TGV having: an aspect ratio of a width to a height of about 1:3 to about 1:40; an adhesion layer disposed on the sidewalls of a respective TGV and on the first surface and the second surface of the glass substrate, the adhesion layer having a thickness of about 20 Angstroms to about 400 Angstroms and a tensile stress of about −30 MPa to about 50 MPa; a second layer disposed over the adhesion layer on the sidewalls of the respective TGV and disposed over the first surface and the second surface, the second layer having a thickness of about 2,000 Angstroms to about 60,000 Angstroms; and a metal material disposed in the respective TGV and on the second layer over the first surface and the second surface of the glass substrate.

### BRIEF DESCRIPTION OF THE DRAWINGS

So that the manner in which the above recited features of the disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of scope, for the disclosure may admit to other equally effective implementations.

FIG. 1 is a cross-sectional view of a prior art through glass via and liner layer.

FIG. 2a is a cross-sectional view of a prior art through glass via showing a delaminated liner layer under tensile stress.

FIG. 2b is a cross-sectional view of a prior art through glass via showing a delaminated liner layer under compressive stress.

FIG. 3a is a cross-sectional view of a through glass via and liner layer according to one or more implementations described herein.

FIG. 3b is a cross-sectional view of a through glass via and liner layer according to one or more implementations described herein.

FIG. 4 is a partial, cross-sectional view of the through glass via of FIG. 3a, according to one or more implementations described herein.

FIGS. 5a-5c are partial, cross-sectional views illustrating the formation of a liner layer, according to one or more implementations described herein.

FIG. 6a is a cross-sectional view of an interposer panel and liner layer according to one or more implementations described herein.

FIG. 6b is a cross-sectional view of an interposer panel and liner layer according to one or more implementations described herein.

FIG. 7 is a flow diagram of a method of forming a liner layer, according to one or more implementations described herein.

FIG. 8 is a flow diagram of a method of forming a liner layer, according to one or more implementations described herein.

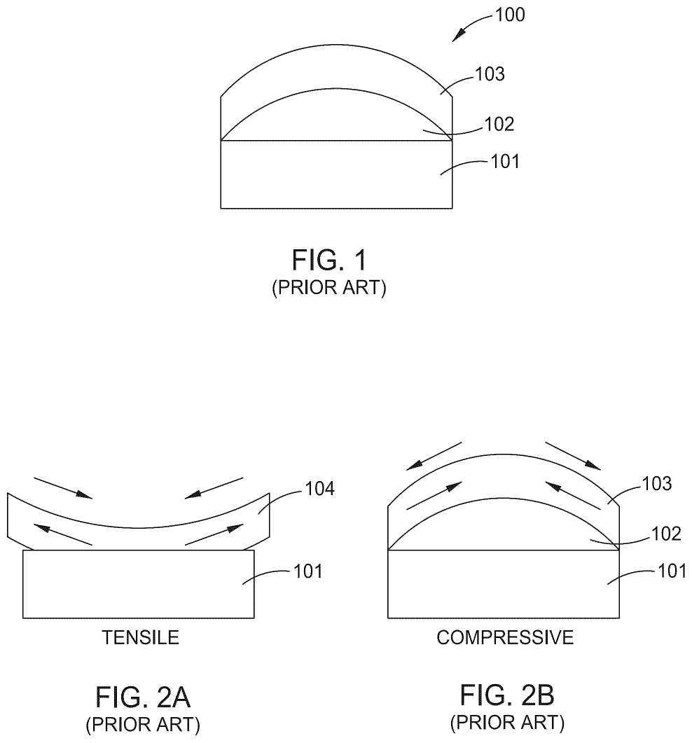

To facilitate understanding, identical reference numerals have been used, where possible, to designate identical elements that are common to the Figures. It is contemplated that elements and features of one implementation may be beneficially incorporated in other implementations without further recitation.

### DETAILED DESCRIPTION

Implementations of the present disclosure generally relate to liner layers and methods of forming liner layers in through glass vias for the production of semiconductor chip packaging and electronic devices. More particularly, implementations described herein provide methods for forming liner layers that prevents delamination between through glass vias and the liner layers. It has been discovered that liner layers can be tuned, using the methods described herein, to prevent delamination by altering the characteristics of the portion of the liner layer adjacent the glass to improve adhesion and counteract the potential compressive stress of the upper portion of the liner layer resulting in more cohesive and efficient semiconductor chip packaging and electronic devices.

At least some implementations herein describe liner layers that utilizes a combination of a first adhesion layer, with either a tensile stress of about −30 MPa to about 200 MPa or a Young's modulus greater than 115 GPa, and a second layer disposed on the adhesion layer to prevent liner layer delamination. In at least one implementation, the liner layer is a single layer, such as an adhesion layer with different layer characteristics in the portion of the adhesion layer adjacent to the glass and the upper portion of the adhesion layer. In at least one implementation, the liner layer includes a silicon nitride adhesion layer that has a thickness of less than 500 Angstroms and a Young's modulus of greater than 120 GPa in combination with a silicon dioxide second layer having a thickness of greater than 2,000 Angstroms. The use of a silicon nitride adhesion layer provides better adhesion to the glass than a conventional PECVD TEOS based silicon dioxide layer. Using an adhesion layer having a Young's modulus of greater than 115 GPa adds rigidity to the base of the layer, making it less susceptible to delamination by the compressive stress of the second layer. In at least one implementation, the liner layer includes a silicon oxycarbide adhesion layer that has a thickness of less than 500 Angstroms and a tensile stress of about −30 MPa to about 50 MPa in combination with a silicon dioxide second layer having a thickness of greater than 2,000 Angstroms. In at least one implementation, the liner layer includes a silicon dioxide adhesion layer that has a thickness of less than 500 Angstroms and a tensile stress of about 30 MPa to about 200 MPa in combination with a silicon dioxide second layer having a thickness of greater than about 2,000 Angstroms. The use of a thin silicon oxycarbide or silicon dioxide adhesion layer having a tensile stress provides an opposing force to the compressive stress of a second layer or modified upper portion of the adhesion layer, preventing delamination. In addition, low tensile stress values decrease the elastic energy stored in the liner layer, lowering the liner layers potential for delamination.

### Through Glass Vias

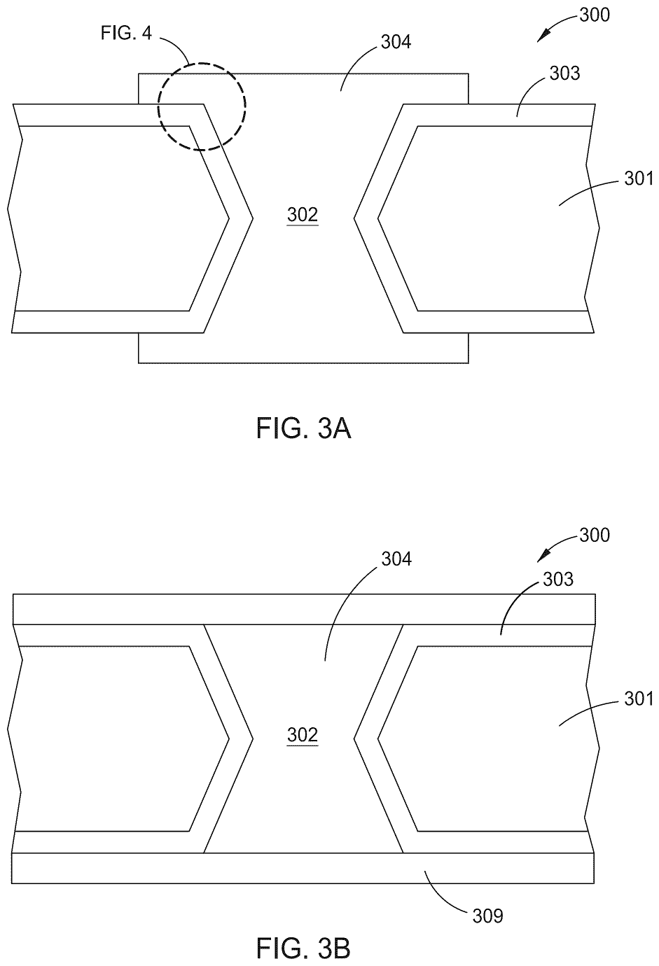

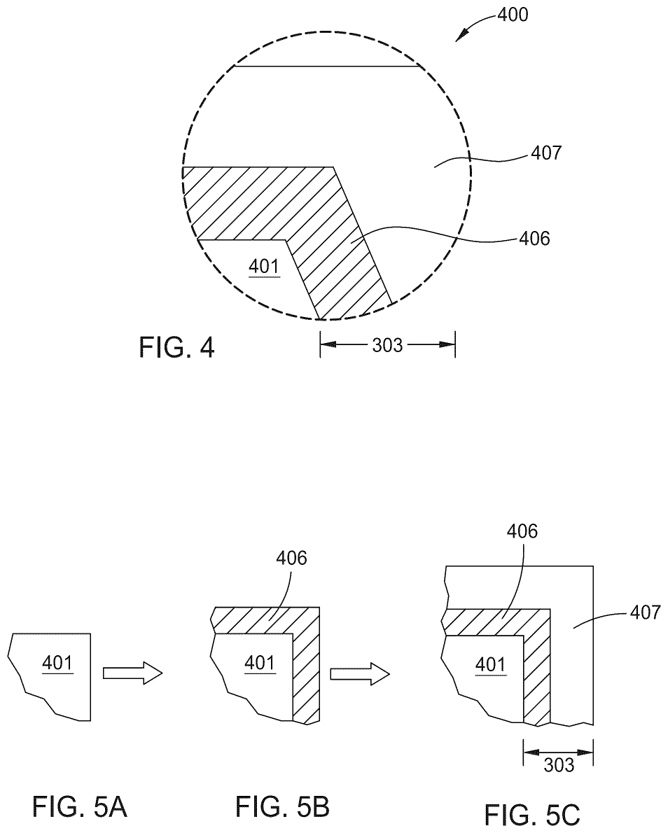

FIGS. 3a and 3b depict cross-sectional views of a through glass via 300 according to one or more implementations described herein. The through glass via 300 includes a glass substrate 301 and a via 302 disposed through the glass substrate 301. Though only one via is shown, via 302 is representative of a plurality of vias (not shown) disposed throughout the glass substrate 301. A liner layer 303 is deposited on the glass substrate 301, such as being deposited on and in the via (such as via 302) of the plurality of vias. The liner layer 303 acts as a buffer between the glass substrate 301 and the copper layer 304. The copper layer 304 can extend over the top and bottom surface of the lined glass substrate 301 forming surface pads as shown in FIG. 3a or be flush with the lined glass substrate 301 as shown in FIG. 3b. In at least one implementation, an organic buildup layer 309 is deposited over the copper layer 304 and the exposed liner layer 303. In at least one implementation, which can be combined with other implementations, liner layer 303 includes at least two layers, 406 and 407, illustrated in more detail in FIG. 4.

FIG. 4 is a partial, cross-sectional view of a through glass via of FIG. 3 taken from an edge portion 400 of via 302, as seen in at least some implementations. Edge portion 400 depicts the liner layer 303 disposed on surface 401, where liner layer 303 is a stack of two layers, the adhesion layer 406 and the second layer 407. The adhesion layer and the second layer are deposited or otherwise produced from one or more chemical vapor deposition (CVD) processes which can be or include PECVD and subatmospheric pressure CVD (SACVD). FIGS. 5a-5c are schematic partial sectional views illustrating the progressive formation of the liner layer 303, according to one or more implementations. In some implementations, the adhesion layer 406 is deposited on surface 401 using either PECVD or SACVD. The adhesion layer 406 may be a silicon nitride layer, a silicon oxycarbide layer, a silicon dioxide layer, or combination thereof. In some implementations, the second layer 407 is deposited on the adhesion layer 406 using a PECVD method. The second layer 407 may be a silicon dioxide film. In some implementation, the adhesion layer and the second layer are deposited sequentially in a single processing chamber. In other implementations, the adhesion layer is deposited in a first processing chamber and the second layer is deposited in a second processing chamber, without a vacuum break between the first and second chambers.

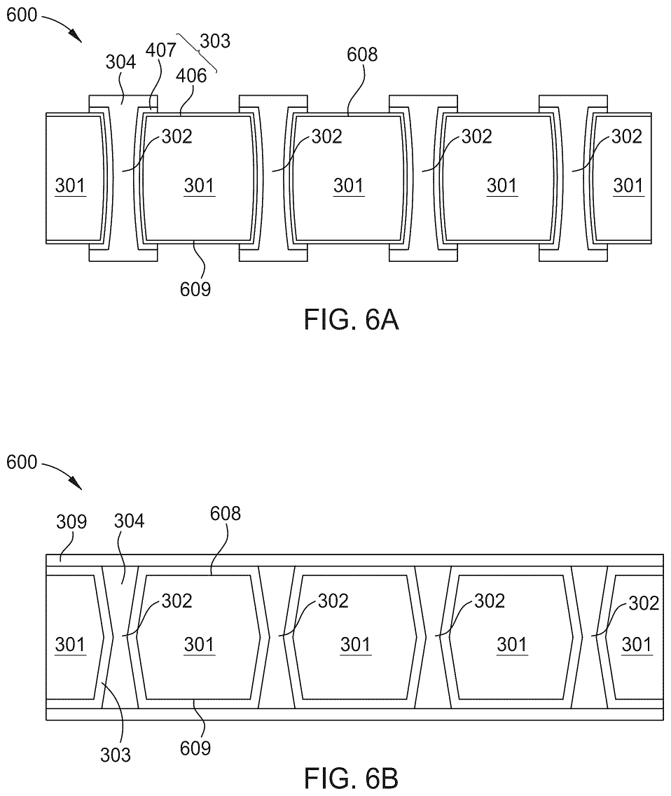

FIG. 6 depicts a cross-sectional view of an interposer panel 600 according to one or more implementations described herein. The interposer panel 600 includes a glass substrate 301 having a first surface 608 and a second surface 609 opposing the first surface 608. The glass substrate 301 has a plurality of vias 302 disposed through the glass substrate 301. The vias 302 have an aspect ratio of a width to a height of about 1:3 to about 1:40, such as about 1:4 to about 1:30, about 1:4 to about 1:20, about 1:6 to about 1:20, about 1:10 to about 1:40, or about 1:10 to about 1:30. A liner layer 303 is deposited on the glass substrate 301, such as being deposited on and in the vias 302. The liner layer 303 is a stack of two layers, the adhesion layer 406 and the second layer 407. The adhesion layer 406 is deposited on the sidewalls of the vias 302 and on the first surface 608 and the second surface 609. The second layer is deposited over the adhesion layer 406 on the sidewalls of the vias 302 and on the first surface 608 and the second surface 609. A metal material, such as copper layer 304, is disposed in the vias 302 and on the second layer 407 over the first surface 608 and second surface 609. In some implementations, the second layer 407 completely covers the adhesion layer 406. In other implementations, the second layer 407 partially covers the adhesion layer 406, such as being deposited on the sidewalls of the vias 302 and extending partially over the adhesion layer 406 on the first surface 608 and second surface 609, such that the second layer 407 covers a defined area surrounding the openings of the vias 302. In some implementations, the copper layer 304, is disposed in the vias 302 without extending to the second layer 407 over the first surface 608 and second surface 609, as shown in FIG. 6b, such that the copper layer is flush with the liner layer 303 over the first surface 608 and second surface 609. An organic buildup layer 309 may be deposited over the copper layer 304 and the exposed liner layer 303.

Implementations discussed herein disclose methods for preventing delamination by targeting characteristics in the portion of the liner layer directly deposited on the glass substrate, adhesion layer 406. Examples of adhesion layer characteristics include Young's modulus, layer thickness, and film stress, which can be related to the elastic energy stored in the liner layer and delamination using equation 1 and equation 2:

$$U = \frac{{S}^{2} δ}{E} \geq {U}_{cd} \qquad Eq . 1$$

$${δ}_{cd} ≃ \frac{{γ}_{d} E}{{S}^{2}} \qquad Eq . 2$$

where U: elastic energy stored in the layer; U_{cd}: critical energy for delamination; S: film stress; E: Young's modulus of the layer; δ: layer thickness; δ_{cd}: critical layer thickness for delamination; ν: poisson's ratio; γ: surface energy; γ_{d}: delamination surface energy. In some implementations, which can be combined with other implementations, the portion of the liner directly deposited on the glass substrate (adhesion layer 406) has a Young's modulus (E) greater than about 115 GPa. Some implementations have shown that adhesion layers having Young's modulus greater than about 115 GPa are rigid, and thus have little elastic energy stored in the layer (U) resulting in better adhesion layer adhesion to the glass substrate which provides an opposing force to the compressive stress of a second layer or modified upper portion of the adhesion layer, preventing delamination. In other implementations, the adhesion layer 406 has a tensile stress(S), for example, a tensile stress of about −30 MPa to about 200 MPa. Some implementations have shown that a thin, such as about 500 Angstroms or less, adhesion layer having a tensile stress has little elastic energy stored in the layer (U) resulting in better adhesion layer adhesion to the glass substrate. The tensile stress of the thin adhesion layer provides enough of an opposing force to the compressive stress of a second layer or modified upper portion of the adhesion layer to preventing delamination. The characteristics of the adhesion layer and second layer are further discussed below.

In some implementations, which can be combined with other implementations, the adhesion layer, such as adhesion layer 406, has a thickness of about 20 Angstroms to about 750 Angstroms, such as about 700 Angstroms or less, about 500 Angstroms or less, about 400 Angstroms or less, about 300 Angstroms or less, or about 200 Angstroms or less. For example the adhesion layer 406 may have a thickness of about 20 Angstroms to about 400 Angstroms, about 20 Angstroms to about 200 Angstroms, about 100 Angstroms to about 750 Angstroms, about, 100 Angstroms to about 550 Angstroms, about 200 Angstroms to about 400 Angstroms, about 300 Angstroms to about 500 Angstroms, about 400 Angstroms to about 700 Angstroms, or about 250 Angstroms to about 720 Angstroms. In other implementations, the adhesion layer, such as adhesion layer 406, has a thickness of about 100 Angstroms to about 10,000 Angstroms, such as about 200 Angstroms to about 10,000 Angstroms, about 500 Angstroms to about 10,000 Angstroms, about 2,000 Angstroms to about 10,000 Angstroms, about 4,000 Angstroms to about 10,000 Angstroms, or about 2,000 Angstroms to about 5,000 Angstroms. For example the adhesion layer 406 may be the only layer of the liner layer and have a thickness of about 4,000 Angstroms to about 10,000 Angstroms.

In some implementations, which can be combined with other implementations, the adhesion layer 406 has a tensile stress of about −30 MPa to about 200 MPa, such as about −30 MPa to about 100 MPa, about −30 MPa to about 80 MPa, about −15 MPa to about 80 MPa, about −30 MPa to about 50 MPa, or about −5 MPa to about 20 MPa. The adhesion layer 406 may have a positive tensile stress such as about 0.1 MPa to about 200 MPa, about 0.1 MPa to about 100 MPa, about 10 MPa to about 200 MPa, about 30 MPa to about 200 MPa, or about 30 MPa to about 150 MPa. For example, the adhesion layer may be a silicon oxycarbide layer deposited using PECVD having a tensile stress of about −30 MPa to about 50 MPa, such as about −20 MPa to about 40 MPa, about −15 MPa to about 30 MPa, about 0.1 MPa to about 50 MPa, about −5 MPa to about 20 MPa, or about 10 MPa to about 40 MPa. In another example, the adhesion layer may be a silicon nitride layer deposited using PECVD having a tensile stress of about −30 MPa to about 80 MPa, such as, about −30 MPa to about 60 MPa, about −20 MPa to about 40 MPa, about −15 MPa to about 30 MPa, or about 10 MPa to about 80 MPa. In yet another example, the adhesion layer may be a silicon dioxide layer deposited using SACVD having a tensile stress of about 30 MPa to about 200 MPa, such as, about 30 MPa to about 150 MPa, about 80 MPa to about 150 MPa, or about 30 MPa to about 100 MPa.

In some implementations, which can be combined with other implementations, the adhesion layer 406 has a Young's modulus greater than 115 GPa, such as about 115 GPa to about 200 GPa, about 120 GPa to about 200 GPa, or about 120 GPa to about 150 GPa. For example the adhesion layer may be a silicon nitride layer deposited using PECVD having a Young's modulus of about 115 GPa to about 200 GPa, such as about 120 GPa to about 200 GPa, or about 120 GPa to about 150 GPa. In some implementations, which can be combined with other implementations, the adhesion layer 406 has a Young's modulus of about 80 GPa to about 170 GPa. In some implementations, which can be combined with other implementations, the adhesion layer 406 has a Young's modulus of about 1 GPa to about 50 GPa, such as about 1 GPa to about 40 GPa, about 1 GPa to about 30 GPa, or about 1 GPa to about 20 GPa. For example, the adhesion layer may be a silicon oxycarbide layer deposited using PECVD having a Young's modulus of about 1 GPa to about 50 GPa, such as about 1 GPa to about 40 GPa, or about 1 GPa to about 20 GPa. In another example, the adhesion layer may be a silicon dioxide layer deposited using SACVD having a Young's modulus of about 1 GPa to about 50 GPa, such as about 1 GPa to about 40 GPa, or about 1 GPa to about 20 GPa.

In some implementations, which can be combined with other implementations, the second layer 407 has a thickness of about 2,000 Angstroms to about 150,000 Angstroms, such as about 2,000 Angstroms to about 100,000 Angstroms, about 2,000 Angstroms to about 60,000 Angstroms, about 2,000 Angstroms to about 50,000 Angstroms, about 2,000 Angstroms to about 30,000 Angstroms, about 2,000 Angstroms to about 10,000 Angstroms, or about 2,000 Angstroms to about 5,000 Angstroms. For example the second layer 407 may have a thickness of about 2,000 Angstroms to about 60,000 Angstroms.

In some implementations, which can be combined with other implementations, the second layer 407 may have a compressive stress of greater than −50 MPa, such as about −80 MPa, about −100 MPa, about −200 MPa, about −350 MPa. For example, the second layer 407 may have a compressive stress of about −400 MPa to about −50 MPa, about −350 MPa to about −50 MPa, or about −200 MPa to about −80 MPa. The second layer 407 may also have a Young's modulus of about 30 GPa to about 80 GPa, such as about 35 GPa to about 70 GPa, about 30 GPa to about 50 GPa, or about 40 GPa to about 60 GPa. For example the second layer 407 may be a silicon dioxide layer deposited using PECVD having a stress of about −350 MPa to about −50 MPa and a Young's modulus of about 35 GPa to about 70 GPa.

In at least one implementation, an interposer panel, such as interposer panel 600, has an adhesion layer having a thickness of about 100 Angstroms to about 400 Angstroms, a tensile stress of about −15 MPa to about 80 MPa, and a Young's modulus of about 80 GPa to about 150 GPa. A second layer having a thickness of about 2,000 Angstroms to about 60,000 Angstroms is disposed over the adhesion layer. In another implementation, an interposer panel has an adhesion layer having a thickness of about 250 Angstroms to about 720 Angstroms and a tensile stress of about 30 MPa to about 200 MPa. A second layer having a thickness of about 2,000 Angstroms to about 60,000 Angstroms is disposed over the adhesion layer. In yet another implementation, an interposer panel has an adhesion layer having a thickness of about 100 Angstroms to about 400 Angstroms and a tensile stress of about −30 MPa to about 50 MPa. A second layer having a thickness of about 2,000 Angstroms to about 60,000 Angstroms is disposed over the adhesion layer.

### Methods

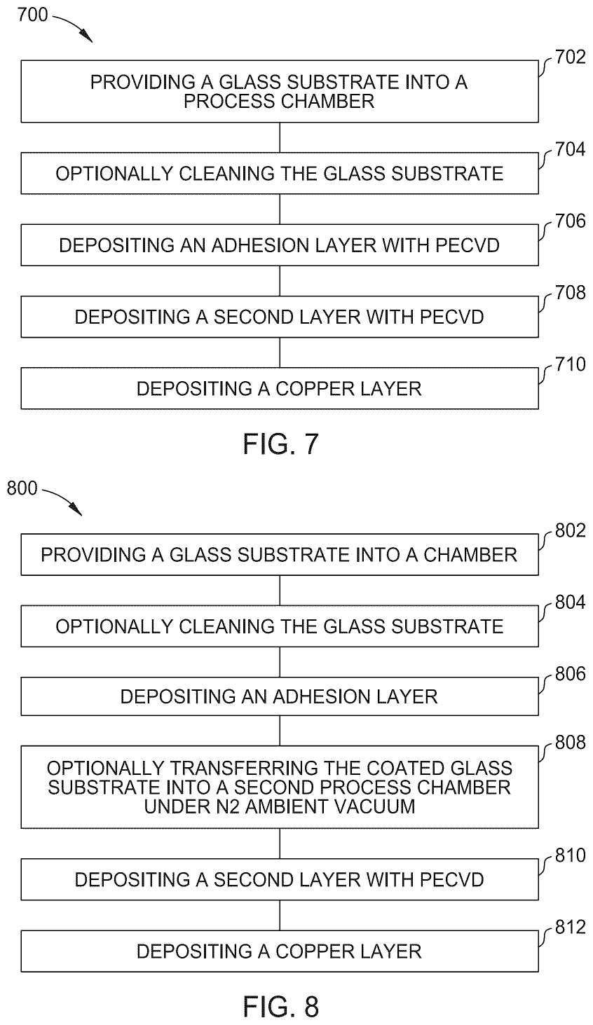

FIG. 7 is a schematic block diagram of a method of forming a liner layer, according to one or more implementations. Method 700 may be carried out in any suitable process chamber or multiple process chambers. Examples of suitable processing chambers include, but are not limited to, AKT-CVD process chambers, such as AKT 55S PECVD, AKT-PX PECVD, AKT50K, or Endura® Volta® integrated processing system, available from AKT, a division of Applied Materials, Inc., Santa Clara, California.

Operation 702 includes positioning a glass substrate in a processing chamber. The glass substrate is positioned on a support that is positioned at a predetermined distance from a gas diffuser. The predetermined distance can be about 250 mils to about 1100 mils.

Operation 704 includes optionally cleaning the glass substrate with a pre-plasma treatment. The glass substrate may be cleaned using any suitable method. In at least one implementation, which can be combined with other implementations, the glass substrate is cleaned by introducing a gas into a chamber, the gas including H₂, NH₃, N₂O, N₂, O₂, O₃, Ar, He, or combinations thereof, and operating the process chamber at a temperature of about 150 degrees Celsius to about 400 degrees Celsius, a pressure of about 500 mTorr to about 1500 mTorr, and a radio-frequency (RF) of about 0.15 W/cm² to about 0.4 W/cm².

Operation 706 includes depositing an adhesion layer onto the glass substrate. In one or more implementations, a PECVD process is employed to deposit the adhesion layer. Depositing the adhesion layer includes: flowing one or more gases into the process chamber and operating the process chamber at a temperature of about 150 degrees Celsius to about 350 degrees Celsius, a pressure of about 600 mTorr to about 1,800 mTorr, and a radio-frequency (RF) power of about 0.1 W/cm² to about 0.7 W/cm² to deposit a film having a thickness about 100 Angstroms to about 750 Angstroms.

In at least one implementation, which can be combined with other implementations, the one or more gases include hexamethyldisiloxane (HMDSO) and nitrous oxide. In at least one implementation of depositing the adhesion layer, HMDSO and nitrous oxide are flowed at a ratio of HMDSO gas/nitrous oxide of about 0.03 to about 0.16 into the process chamber. The process chamber is operated at a temperature of about 150 degrees Celsius to about 350 degrees Celsius, such as about 150 degrees Celsius to about 250 degrees Celsius, or about 200 degrees Celsius to about 300 degrees Celsius, or about 200 C to about 350 C, a pressure of about 600 mTorr to about 1,800 mTorr, such as about 650 mTorr to about 1,300 mTorr, about 650 mTorr to about 900 mTorr or about 900 mTorr to about 1,200 mTorr, and an RF power of about 0.25 W/cm² to about 0.55 W/cm². The resulting adhesion layer includes silicon oxycarbide and has a tensile stress of about −30 MPa to about 50 MPa, such about −20 MPa to about 40 MPa, about −15 MPa to about 30 MPa, about 0.1 MPa to about 50 MPa, or about 10 MPa to about 40 MPa and a Young's modulus of about 1 GPa to about 50 GPa. In at least one implementation, the ratio of volumes of HMDSO to nitrous oxide is about 1:3 to about 1:30, such as a ratio of volumes of about 1:3 to about 1:20, or about 1:10 to about 1:30. For example, in at least one implementation, HMDSO is flowed into the process chamber at a rate of about 600 SCCM to about 750 SCCM and nitrous oxide is flowed into the process chamber at a rate of about 13,000 SCCM to about 14,500 SCCM.

In at least another implementation, which can be combined with other implementations, the one or more gases include HMDSO, nitrous oxide, and silicon tetrafluoride. In at least one implementation of depositing the adhesion layer, HMDSO and nitrous oxide are flowed at a ratio of HMDSO gas/nitrous oxide of about 0.3 to about 1.5 and silicon tetrafluoride is flowed at a ratio of HMDSO gas/silicon tetrafluoride of about 0.75 to about 2.3 into the process chamber. The process chamber is operated at a temperature of about 150 degrees Celsius to about 350 degrees Celsius, such as about 150 degrees Celsius to about 250 degrees Celsius, or about 200 degrees Celsius to about 300 degrees Celsius, or about 200 C to about 350 C, a pressure of about 900 mTorr to about 1,800 mTorr, and a radio frequency power of about 0.2 W/cm² to about 0.55 W/cm². The resulting adhesion layer includes fluorine and silicon oxycarbide and has a tensile stress of about −5 MPa to about 20 MPa such as, about −5 MPa to about 15 MPa, about −5 MPa to about 10 MPa, or about 0.1 MPa to about 20 MPa and a Young's modulus of about 1 GPa to 50 GPa. In at least one implementation the ratio of volumes of HMDSO and nitrous oxide is about 1:0.5 to about 1:5, such as a ratio of volumes of about 1:2 to about 1:4. For example, in at least one implementation, HMDSO is flowed at a rate of about 600 SCCM to about 750 SCCM, nitrous oxide is flowed at a rate of about 13,000 SCCM to about 14,500 SCCM, and silicon tetrafluoride is flowed at a rate of about 550 SCCM to about 650 SCCM into the process chamber.

In at least another implementation, which can be combined with other implementations, the one or more gases include a silicon containing gas and ammonia. The adhesion layer may be deposited using any suitable method that results in an adhesion layer including silicon nitride having a Young's modulus of about 115 GPa to about 200 GPa, such as about 120 GPa to about 200 GPa, or about 120 GPa to about 150 GPa and a tensile stress of about −30 MPa to about 80 MPa, such as about −15 MPa to about 80 MPa, about −30 MPa to about 50 MPa, or about −5 MPa to about 20 MPa. For example, in at least one implementation of depositing the adhesion layer, a silicon containing gas and ammonia are flowed into the process chamber. The process chamber is operated at a temperature of about 150 degrees Celsius to about 350 degrees Celsius, a pressure of about 650 mTorr to about 1,600 mTorr, and a radio frequency power of about 0.2 W/cm² to about 0.6 W/cm² to deposit the adhesion layer including silicon nitride.

Operation 708 includes depositing a second layer onto the adhesion layer. In one implementation, a PECVD process is employed to deposit the second layer. Depositing the second layer includes: flowing one or more gases into the process chamber and operating the process chamber at a temperature of about 150 degrees Celsius to about 450 degrees Celsius, a pressure of about 650 m Torr to about 900 mTorr, and an RF power of about 0.2 W/cm² to about 0.4 W/cm².

In at least one implementation, which can be combined with other implementations, the one or more gases include tetraethyl orthosilicate gas and oxygen.

In at least one implementation of depositing the second layer, tetraethyl orthosilicate gas and oxygen are flowed at a ratio of tetraethyl orthosilicate gas/oxygen of about 0.02 to about 0.035 into the process chamber. The process chamber is operated at a temperature of about 150 degrees Celsius to about 450 degrees Celsius, such as about 150 degrees Celsius to about 250 degrees Celsius, or about 200 degrees Celsius to about 300 degrees Celsius, a pressure of about 650 mTorr to about 900 mTorr, and an RF power of about 0.2 W/cm² to about 0.4 W/cm². The resulting second layer includes silicon dioxide.

Operation 710 includes depositing a copper seed layer onto the second layer. The copper seed layer may be deposited using any suitable method including electroplating, CVD, Physical Vapor Deposition (PVD), or a combination of these methods. For example, the copper layer may be deposited by PVD sputtering, where conditions include: spacing a target copper cathode and the lined glass substrate at a distance of about 44 millimeters to about 60 millimeters, applying a DC power to the target copper cathode in a range of about 1 kW to about 18 KW without applying a bias to the substrate, and operating the process chamber at a pressure of about 0.1 mTorr to about 5 m Torr under argon.

FIG. 8 is a schematic block diagram of a method of forming a liner layer, according to one or more implementations. Method 800 may be carried out in any suitable process chamber, such as cluster processing systems or single chamber systems capable of both SACVD and PECVD processes.

Operation 802 includes positioning a glass substrate in a first processing chamber. The glass substrate is positioned on a support that is positioned at a predetermined distance from a gas diffuser. The predetermined distance is about 250 mils to about 1100 mils.

Operation 804 includes optionally cleaning the glass substrate with a pre-plasma treatment. The glass substrate may be cleaned using any suitable method. In at least one implementation, which can be combined with other implementations, the glass substrate is cleaned by introducing a gas into a chamber, the gas including H₂, NH₃, N₂O, N₂, O₂, O₃, Ar, He, or combinations thereof, and operating the process chamber at a temperature of about 150 degrees Celsius to about 400 degrees Celsius, a pressure of about 500 mTorr to about 1500 mTorr, and a radio-frequency (RF) of about 0.15 W/cm² to about 0.4 W/cm².

Operation 806 includes depositing an adhesion layer onto the glass substrate. In one implementation, a SACVD process is employed to deposit the adhesion layer. Depositing the adhesion layer includes: flowing one or more gases into the first process chamber and operating the first process chamber at a temperature of about 300 degrees Celsius to about 450 degrees Celsius and a pressure of about 50 Torr to about 600 Torr, such as about 60 Torr to about 600 Torr, about 50 Torr to about 90 Torr or about 450 Torr to about 550 Torr.

In one implementation, which can be combined with other implementations the one or more gases include tetraethyl orthosilicate gas, and ozone. In at least one implementation of depositing the adhesion layer, tetraethyl orthosilicate gas and ozone are flowed at a ratio of tetraethyl orthosilicate gas/ozone of about 0.002 to about 0.012 into the first process chamber. The first process chamber is operated at a temperature of about 300 degrees Celsius to about 450 degrees Celsius, such as about 350 degrees Celsius to about 425 degrees Celsius, and a pressure of about 450 Torr to about 600 Torr, such as about 450 Torr to about 550 Torr. The resulting adhesion layer includes silicon dioxide and has a tensile stress of about 30 MPa to about 200 MPa, such as about 150 MPa to about 200 MPa. For example, in at least one implementation, tetraethyl orthosilicate gas is flowed at a rate of about 650 SCCM to about 750 SCCM and ozone is flowed at a rate of about 26,000 SCCM to about 28,000 SCCM into the first process chamber. In another implementation, the one or more gases may further include oxygen.

In another implementation, which can be combined with other implementations the one or more gases include tetraethyl orthosilicate gas and ozone. In at least one implementation of depositing the adhesion layer, tetraethyl orthosilicate gas and ozone are flowed at a ratio of tetraethyl orthosilicate gas/ozone of about 0.002 to about 0.012 into the first process chamber. The first process chamber is operated at a temperature of about 300 degrees Celsius to about 450 degrees Celsius, such as about 350 degrees Celsius to about 425 degrees Celsius, and a pressure of about 50 Torr to about 90 Torr, such as about 60 Torr to about 80 Torr. The resulting adhesion layer includes silicon dioxide and has a tensile stress of about 30 MPa to about 200 MPa, such as about 60 MPa to about 100 MPa. For example, in at least one implementation, tetraethyl orthosilicate gas is flowed at a rate of about 650 SCCM to about 750 SCCM and ozone is flowed at a rate of about 26,000 SCCM to about 28,000 SCCM into the first process chamber. In another implementation, the one or more gases may further include oxygen.

Operation 808 includes optionally transferring the coated glass substrate into a second process chamber under N₂ without breaking vacuum between the two chambers. In at least one implementation, which can be combined with other implementations, method 800 is performed in a multi chamber system, where the first and second processing chambers are connected directly or connected via a transfer chamber that is maintained under vacuum and N₂. The lack of a vacuum break between the deposition of the adhesion layer and the second layer minimizes the likelihood of surface contamination resulting in a more adherent liner layer.

Operation 810 includes depositing a second layer onto the adhesion layer. In one implementation, a PECVD process is employed to deposit the second layer. Depositing the second layer includes: flowing one or more gases into the first or second process chamber and operating the first or second process chamber at a temperature of about 150 degrees Celsius to about 450 degrees Celsius, a pressure of about 650 m Torr to about 900 mTorr, and an RF power of about 0.2 W/cm² to about 0.4 W/cm².

In at least one implementation, which can be combined with other implementations, the one or more gases include tetraethyl orthosilicate gas and oxygen. In at least one implementation of depositing the second layer, tetraethyl orthosilicate gas and oxygen are flowed at a ratio of tetraethyl orthosilicate gas/oxygen about 0.02 to about 0.035 into the process chamber and the process chamber is operated at a temperature of about 150 degrees Celsius to about 450 degrees Celsius, such as about 150 degrees Celsius to about 250 degrees Celsius, or about 200 degrees Celsius to about 300 degrees Celsius, a pressure of about 650 mTorr to about 900 mTorr, and an RF power of about 0.2 W/cm² to about 0.4 W/cm². The resulting second layer includes silicon dioxide.

Operation 812 includes depositing a copper seed layer. The copper seed layer may be deposited using any suitable method including, but not limited to electroplating, CVD, (PVD) or combination of these methods. For example, the copper may be deposited by PVD sputtering, where conditions include: spacing a target copper cathode and the lined glass substrate at a distance of about 44 millimeters to about 60 millimeters, applying a DC power to the target copper cathode in a range of about 1 KW to about 18 kW without applying a bias to the substrate, and operating the process chamber at a pressure of about 0.1 m Torr to about 5 mTorr under argon.

Overall, liner layers and methods of the present disclosure can reduce or prevent delamination by using select layer characteristics in the portions of the liner layer abutting the glass substrate to improve adhesion of the liner layer with the glass substrate and counteract the compressive stress of the upper portion of the liner layer resulting in more cohesive and efficient semiconductor chip packaging and electronic devices. Layer characteristics such as high Young's modulus, add rigidity to the base of the layer, making it less susceptible to delamination by the compressive stress of a second layer or modified upper portion of the adhesion layer, whereas tensile stress in the portions of the liner layer closest to the glass substrate provides an opposing force to the compressive stress of a second layer or modified upper portion of the adhesion layer, preventing delamination.

While the foregoing is directed to implementations of the present disclosure, other and further implementations of the disclosure may be devised without departing from the basic scope thereof. The present disclosure also contemplates that one or more aspects of the implementations described herein may be substituted in for one or more of the other aspects described. The scope of the disclosure is determined by the claims that follow.

Certain implementations and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

An interposer panel, comprising: a glass substrate having a first surface and a second surface opposing the first surface, the glass substrate comprising a plurality of through glass vias (TGVs) disposed through the glass substrate, at least one TGV having: an aspect ratio of a width to a height of about 1:3 to about 1:40; an adhesion layer disposed on sidewalls of a respective TGV and on the first surface and the second surface of the glass substrate, the adhesion layer having a thickness of about 100 Angstroms to about 400 Angstroms, a tensile stress of about −15 MPa to about 80 MPa, and a Young's modulus of about 80 GPa to about 150 GPa; a second layer disposed over the adhesion layer on the sidewalls of the respective TGV and disposed over the first surface and the second surface, the second layer having a thickness of about 2,000 Angstroms to about 60,000 Angstroms; and a metal material disposed in the respective TGV and on the second layer over the first surface and the second surface of the glass substrate.

An interposer panel, comprising: a glass substrate having a first surface and a second surface opposing the first surface, the glass substrate comprising a plurality of through glass vias (TGVs) disposed through the glass substrate, at least one TGV having: an aspect ratio of a width to a height of about 1:3 to about 1:40; an adhesion layer disposed on sidewalls of a respective TGV and on the first surface and the second surface of the glass substrate, the adhesion layer having a thickness of about 250 Angstroms to about 720 Angstroms and a tensile stress of about 30 MPa to about 200 MPa. a second layer disposed over the adhesion layer on the sidewalls of the respective TGV and disposed over the first surface and the second surface, the second layer having a thickness of about 2000 Angstroms to about 60,000 Angstroms; and a metal material disposed in the respective TGV and on the second layer over the first surface and the second surface of the glass substrate.

An interposer panel, comprising: a glass substrate having a first surface and a second surface opposing the first surface, the glass substrate comprising a plurality of through glass vias (TGVs) disposed through the glass substrate, at least one TGV having: an aspect ratio of a width to a height of about 1:3 to about 1:40; an adhesion layer disposed on sidewalls of a respective TGV and on the first surface and the second surface of the glass substrate, the adhesion layer having a thickness of about 100 Angstroms to about 400 Angstroms and a tensile stress of about −30 MPa to about 50 MPa. a second layer disposed over the adhesion layer on the sidewalls of the respective TGV and disposed over the first surface and the second surface, the second layer having a thickness of about 2000 Angstroms to about 60,000 Angstroms; and a metal material disposed in the respective TGV and on the second layer over the first surface and the second surface of the glass substrate.

What is claimed is:

1. A method of forming a liner layer in a via formed on or in a substrate, comprising:
depositing an adhesion layer having a thickness of about 100 Angstroms to about 550 Angstroms, a tensile stress of about −30 MPa to about 80 MPa and a Young's modulus of about 115 GPa to about 200 GPa onto and in a via; and
depositing a second layer onto the adhesion layer, the second layer having a thickness of about 2,000 Angstroms to about 60,000 Angstroms, a compressive stress greater than −50 MPa, and a Young's modulus of about 35 GPa to about 70 GPa.

2. The method of claim 1,
wherein depositing the adhesion layer comprises;
providing a first one or more gases into a first process chamber; and
operating the first process chamber at a temperature of about 150 degrees Celsius to about 350 degrees Celsius, a pressure of about 650 mTorr to about 1,600 mTorr, and a radio-frequency (RF) of about 0.2 W/cm² to about 0.6 W/cm²; and
wherein depositing the second layer comprises;
providing a second one or more gases into the first process chamber; and
operating the first process chamber at a temperature of about 150 degrees Celsius to about 450 degrees Celsius, a pressure of about 650 mTorr to about 900 mTorr, and an RF of about 0.2 W/cm² to about 0.4 W/cm².

3. The method of claim 2, wherein the second one or more gases comprises tetraethyl orthosilicate gas and oxygen; and wherein depositing the second layer comprises providing tetraethyl orthosilicate gas and oxygen at the ratio of tetraethyl orthosilicate gas/oxygen of about 0.02 to about 0.035 into the first process chamber, the second layer comprising silicon dioxide.

4. The method of claim 2, wherein the first one or more gases comprise a silicon containing gas and ammonia; and wherein depositing the adhesion layer comprises providing the silicon containing gas and ammonia into the first processing chamber, the adhesion layer comprising silicon nitride and having a tensile stress of about −30 MPa to about 80 MPa.

5. The method of claim 4, wherein the adhesion layer has a Young's modulus of about 120 GPa to about 200 GPa.

6. The method of claim 1, wherein the adhesion layer and the second layer are deposited sequentially in a single processing chamber.

7. A method of forming a liner layer in a via formed on or in a substrate, comprising:
depositing an adhesion layer having a thickness of about 100 Angstroms to about 550 Angstroms, a tensile stress of about −30 MPa to about 200 MPa, and a Young's modulus of about 1 GPa to about 50 GPa onto and in a via; and
depositing a second layer onto the adhesion layer, the second layer having a thickness of about 2,000 Angstroms to about 60,000 Angstroms, a compressive stress greater than −50 MPa, and a Young's modulus of about 35 GPa to about 70 GPa.

8. The method of claim 7, wherein the adhesion layer and the second layer are deposited sequentially in a single processing chamber.

9. The method of claim 7, wherein depositing the adhesion layer comprises providing HMDSO and nitrous oxide at a ratio of HMDSO gas/nitrous oxide of about 0.03 to about 0.16 into a first process chamber and operating the first process chamber at a pressure of about 600 mTorr to about 1800 mTorr and an RF power of about 0.25 W/cm² to about 0.55 W/cm², the adhesion layer comprising silicon oxycarbide and having a tensile stress of about −30 MPa to about 50 MPa.

10. The method of claim 7, wherein depositing the adhesion layer comprises providing HMDSO and nitrous oxide at a ratio of HMDSO gas/nitrous oxide of about 0.3 to about 1.5 and silicon tetrafluoride at a ratio of HMDSO gas/silicon tetrafluoride of about 0.75 to about 2.3 into a first process chamber and operating the first process chamber at a pressure of about 900 mTorr to about 1800 mTorr and a radio frequency power of about 0.2 W/cm² to about 0.55 W/cm², the adhesion layer comprising fluorine and silicon oxycarbide and having a tensile stress of about −5 MPa to about 20 MPa.

11. The method of claim 7,
wherein depositing the adhesion layer comprises;
providing a first one or more gases into a first process chamber; and
operating the first process chamber at a temperature of about 300 degrees Celsius to about 450 degrees Celsius and a pressure of about 60 Torr to about 600 Torr; and
wherein depositing the second layer comprises;
providing a second one or more gases into the first process chamber or a second process chamber; and
operating the first process chamber or the second process chamber at a temperature of about 150 degrees Celsius to about 450 degrees Celsius, a pressure of about 650 mTorr to about 900 mTorr, and an RF of about 0.2 W/cm² to about 0.4 W/cm².

12. The method of claim 11, wherein the adhesion layer is deposited in the first processing chamber and the second layer is deposited in the second processing chamber, without a vacuum break between the first and second chambers.

13. The method of claim 11, wherein the second one or more gases comprises tetraethyl orthosilicate gas and oxygen; and wherein depositing the second layer comprises providing tetraethyl orthosilicate gas and oxygen at a ratio of tetraethyl orthosilicate gas/oxygen of about 0.02 to about 0.035 into the first process chamber or the second process chamber and operating the first process chamber or the second process chamber at a pressure of about 650 mTorr to about 900 mTorr, the second layer comprising silicon dioxide.

14. The method of claim 11, wherein depositing the adhesion layer comprises providing tetraethyl orthosilicate gas and ozone at a ratio of tetraethyl orthosilicate gas/ozone about 0.002 to about 0.012 into the first process chamber, wherein the adhesion layer comprises silicon dioxide and has a tensile stress of about 30 MPa to about 200 MPa.

15. A liner layer stack, comprising:
a glass substrate, the glass substrate comprising a plurality of vias disposed through the glass substrate; and
an adhesion layer disposed onto and in at least one via of the plurality of vias, the adhesion layer having a thickness of about 100 Angstroms to about 550 Angstroms and one or more of;
a tensile stress of about −30 MPa to about 200 MPa; and
a Young's modulus of about 115 GPa to about 200 GPa.

16. The liner layer of claim 15, further comprising:
a second layer disposed on the adhesion layer, the second layer having a thickness of about 2,000 Angstroms to about 60,000 Angstroms.

17. The liner layer of claim 15, wherein the adhesion layer comprises silicon nitride and has a Young's modulus of about 120 GPa to about 200 GPa.

18. The liner layer of claim 15, wherein the adhesion layer comprises silicon dioxide and has a tensile stress of about 30 MPa to about 200 MPa.

19. The liner layer of claim 15, wherein the adhesion layer comprises silicon oxycarbide and has a tensile stress of about −30 MPa to about 50 MPa.

20. The liner layer of claim 16, wherein the second layer comprises silicon dioxide.

21. The liner layer of claim 20, further comprising a layer of copper seed disposed on the second layer.
